(19) United States
(12) Patent Application Publication
(10) Pub. No.: US 2016/0147084 A1
(43) Pub. Date: May 26, 2016

(54) ELECTRONIC SUNGLASSES

(71) Applicant: John Ramshaw, Mountain House, CA (US)

(72) Inventor: John Ramshaw, Mountain House, CA (US)

(21) Appl. No.: 14/952,694

(22) Filed: Nov. 25, 2015

Related U.S. Application Data
(60) Provisional application No. 62/084,459, filed on Nov. 25, 2014.

(51) Int. Cl. G02C 7/10; H04N 5/225

(52) U.S. Cl. CPC G02C 7/101; H04N 5/2252

(57) ABSTRACT

Electronic viewing apparatus or systems configured to sense and locate bright light sources in the user's field of vision and selectively darken only the portions of the lenses that lie along the lines of sight between the eyes and the bright light sources identified, thereby shielding the eyes from those bright light sources.

### CROSS-REFERENCE TO RELATED APPLICATIONS

This patent application claims the benefit of U.S. Provisional Patent Application No. 62/084,459, filed Nov. 25, 2014, which is incorporated herein by reference.

### BACKGROUND AND SUMMARY

The present disclosure relates generally to wearable electronic devices incorporating lenses, such as electronic glasses or headgear, and in particular to electronic “sunglasses” apparatus or systems configured to sense and locate bright light sources, like the sun, in the user's field of vision and selectively darken only the (usually small) portions of the lenses that lie along the lines of sight between the eyes and the bright light sources identified, thereby shielding the eyes from bright lights. The remainder of the lenses remains fully transparent allowing clear vision of the remainder of the visual field. Thus these electronic sunglasses, unlike ordinary sunglasses, can also be used at night; e.g., to shield the eyes from bright headlights of oncoming vehicles. The lenses respond quickly so that when the wearer turns his or her head, the darkened spots on the lenses move so as to always remain on the direct lines of sight between the eyes and the bright light sources. In general there may be more than one such source (e.g., when the sun is reflected off a car hood, two bright headlights, etc.), and if so there would correspondingly be more than one darkened region, each of which shields the eye from the corresponding bright light source. In certain aspects, electronic sunglasses according to the present disclosure can readily be constructed by combining existing electronic components that are widely used in webcams, digital cameras, smartphones, and LCD displays.

According to an embodiment, a viewing device to be worn by a user having two eyes is provided. The device typically includes a pair of transparent electronic display elements, a support structure for holding the pair of transparent display elements in a fixed relationship, such that when worn by a user, each eye of the user has a field of view through a corresponding one of the display elements. The device also typically includes at least one camera element or imaging element positioned on or proximal to the support structure, and one or more controllers communicably coupled with the pair of display elements and configured to receive image signals from the at least one camera element and to determine positions on the display elements of one or more bright spots in the field of view of the user's eyes, and to produce a dimmed or darkened image at the positions on the display elements so as to reduce a brightness of the one or more bright spots in the user's field of view. The device may also typically include a power source for providing power to the controller and to the pair of transparent electronic display elements. According to another embodiment, a wearable viewing device is provided that typically includes a pair of transparent electronic display elements, a support structure for holding the pair of transparent display elements in a fixed relationship to each other, such that when worn by a user, each eye of the user has a field of view through a corresponding one of said display elements, and at least one camera element positioned on or proximal to the support structure. The device also typically includes one or more controllers communicably coupled with the pair of display elements and configured to receive image signals from the at least one camera element and to determine positions on the display elements corresponding to a bright spot in the field of view of the user's eyes, and to produce a dimmed or darkened image at the positions on the display elements so as to reduce a brightness of the bright spot in the user's field of view. The device also typically includes a power source that supplies operating power to the controller and to the pair of transparent electronic display elements.

In certain aspects, the pair of transparent electronic display elements includes a pair of LCD screens. In certain aspects, the at least one camera element includes an optical lens focused on an image sensor, wherein the image sensor produces said image signals. In certain aspects, the image sensor comprises one of a CCD sensor or a CMOS sensor. In certain aspects, the viewing device includes at least two camera elements, each camera element having an optical lens focused on an image sensor, wherein the image sensors produce the image signals.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 shows an electronic sunglass device according to an embodiment.

### DETAILED DESCRIPTION

The present disclosure relates generally to improved designs of wearable electronic viewing apparatus incorporating electronically-controllable lenses, and in particular to electronic “sunglasses” apparatus or systems such as electronic glasses or headgear configured to sense and locate bright light sources in the user's field of vision and selectively darken only the portions of the lenses that lie along the lines of sight between the eyes and the bright light sources identified, thereby shielding the eyes from those bright light sources.

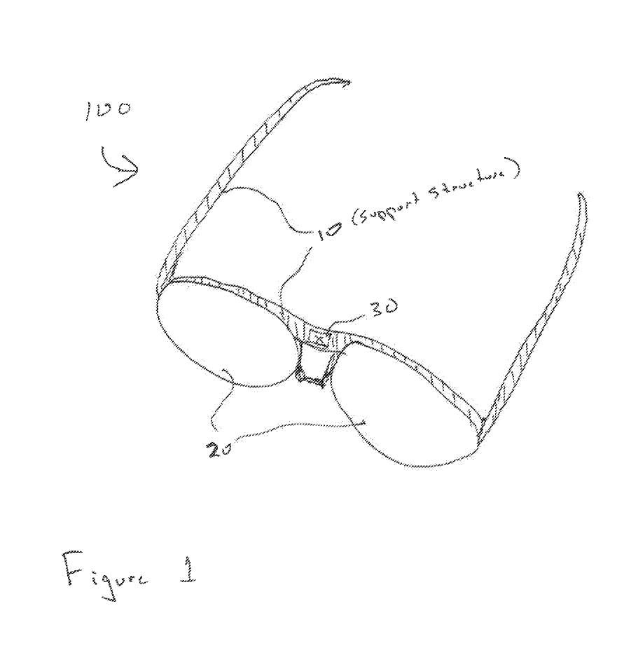

FIG. 1 shows an electronic sunglass device 100 according to an embodiment. Wearable device 100 includes, in one embodiment, one or more camera elements 30, e.g., miniature low-resolution cameras such as webcams, each including an optical lens focused on an image sensor (e.g., CMOS or CCD image sensor) with an integrated image processor/controller. In certain aspects, many of the images captured by these cameras may be ultimately discarded; they are merely a tool for detecting, locating, and determining data for use in obstructing the bright light sources. It should be appreciated that a single image processor/controller may be used to process signals from one or more image sensors, or multiple image processors/controllers may be used. Device 100 also includes two small transparent display screens 20, e.g., LCD display screens, with integrated controllers, on which the images produced by the camera or cameras 30 can be displayed directly in front of each eye of the wearer of device 100. These display screens 20 serve as the lenses of the device, and may be planar or slightly curved similar to the lenses of other types of glasses or eyewear. It should be appreciated that a single display screen controller may be used, or that two (or more) display screen controllers may be used, e.g., a single display controller for two lenses, or two separate display controllers, one for each lens. Device 100 also includes a power source (not shown), such as a small rechargeable battery, e.g., powered by a photocell, to supply power to the electronic components of device 100. The power source may be of the same type used in many handheld electronic calculators which are self-powered by a light source rather than replaceable batteries. A small replaceable backup battery of the same type used in digital watches could also be included. Device 100 also includes a support structure 10, such as glass frames or headgear, configured to hold the display screens 20 in fixed relationship with one another and the eyes of the wearer. The support structure 10 also typically holds one or more of the camera elements 30 and the power source, as well as any communication busses, cables, wires or elements to allow the various controllers/processors and electronic elements to communicate image signals and control signals with each other.

The combined features and settings of the image processor(s)/controller(s) and the display screen controller(s) advantageously support one or more of the following capabilities: (a) image re-centering, so that when each eye looks at a point straight ahead, the image of that point on the LCD display lies on the same line of sight; (b) digital zoom, which is used to shrink or magnify the image so that when the eye is focused on any point in the field of view, the image of that point on the LCD display lies on, or very nearly on, the same line of sight; (c) conversion of color images to grayscale. If YUV webcams are used, the Y signal is already grayscale so no conversion is needed; (d) variable brightness and contrast, so that the contrast can be increased to the point where only the brightest areas of the image are displayed and the remainder of the image is dark; and (e) color inversion (which reduces in the present context to black/white inversion) to interchange the light and dark areas of the image, as in a photographic negative, so that the light areas become dark while the dark areas become transparent. The net result of the above image manipulations is to produce a dark image of a bright light source on the display screens in the direct line of sight between the eye and that light source, thereby shielding the eye from that bright light.

The user's two eyes see slightly different images, which are almost identical for distant objects. Most bright light sources will be relatively distant, so a single webcam may be sufficient to obtain the desired result for both eyes at once. Thus, in certain embodiments, a single camera is used. The single camera would logically be mounted on the center of the device, e.g., nosepiece of glasses, but may be mounted elsewhere. In other embodiments, two or more cameras are used. For example, left and right cameras could be mounted on the left and right sides of the device (e.g., for glasses, on corners where the earpieces are attached), and an optional third camera could be mounted on the center of the device, e.g., nosepiece. The darkened areas in the resulting images could then be slightly shifted to the left or right in proportion to the horizontal separations between the eyes and the cameras to approximate the perspective view of each eye. The image processing capability is programmed on the display screen controller(s) or a separate image processing device.

In certain embodiments, the wearer/user is provided with the additional functionality of using the display screen controller to polarize and/or filter the light passing through the transparent portions of the lenses. For example, visibility in fog could be improved by tinting the pixels reddish-brown so as to filter out blue light. Such additional features could be activated/deactivated by means of a small switch or button on the frame.

In various embodiments, the device identifies the bright spots or areas in the user's field of vision and determines the locations of the corresponding darkened spots or areas on the display screen to ensure that they both lie on the same lines of sight, so that those dark spots or areas overlay, obstruct, and shield the eye from the bright spots or areas. This is accomplished, in one embodiment, as follows. First, the entire image on the display screen is shifted horizontally and/or vertically until the central point of the image lies directly on the user's line of sight when the eye is looking straight ahead (in the direction normal to the focal plane of the camera which produced the image). Second, the size of the image on the display screen is scaled (i.e., shrunk or magnified) by using digital zoom to zoom out or in until the outline or profile of the image on the display screen of any object in the user's field of view overlays and becomes nearly congruent with the outline or profile of the object itself.

The solid angle subtended by any such object relative to the user's eye is then nearly the same as the solid angle subtended by its image on the display screen, so that the latter image very nearly overlays the user's view of the actual object, thereby ensuring that the two lie on the same line of sight. It will be appreciated that the described centering and zooming of the image are geometrically determined by the positioning of the display screen relative to the eye, and that said positioning is held fixed by the frames in which the display screen is mounted and therefore does not change significantly as the user moves his/her head or looks in different directions. This feature is important, because it implies that there is no need to dynamically re-center and/or re-zoom the image in real time, so that the centering and/or zooming parameters for any particular frame design can easily be empirically predetermined to a high degree of accuracy and then preset and incorporated into the firmware configuration of the device, e.g., prior to sale. In some embodiments, the device includes features which allow the user to make fine adjustments of the centering and/or zooming parameters manually, for example by press-hold-release of one or more small buttons; small knobs, wheels, or sliders; turning miniature screws with a jeweler's screwdriver; or other functionally equivalent manual controls. The actual image on the display screen may, and normally will, vary with time due to the relative motion between the position and orientation of the user's head and the objects (notably bright light sources) in the user's field of view, just as the display on a digital camera or cell phone continually changes as such devices are moved around, but the scaling and zoom parameters themselves remain fixed during such motions. Because the camera that produces the images is in effect rigidly attached to the user's head by the frames, the perspective views of the camera images and the user remain essentially the same, so that the image on the display screen of an object in the user's field of view will automatically continue to overlay the user's view of the object itself, even as both are changing.

Once the image has been centered and scaled as described above, the bright spots or areas therein are identified by increasing the contrast of the displayed image to the point where only the very brightest areas remain visible and the remainder of the image is very dark or nearly black.

The resulting bright areas on a nearly black background are then converted into very dark or nearly black areas on a transparent background, e.g., by black/white inversion. By construction, as described above, the resulting dark spot or area on the display screen corresponding to each bright light source lies on the direct line of sight between that light source and the eye, thereby shielding the eye from said light source.

It should be appreciated that device 100 could be implemented in or as a head's-up display device, a video game virtual reality display device, an automobile rearview mirror (camera(s) may be mounted on mirror, on back of car, or elsewhere), a heads-up display on an automobile windshield, etc.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A viewing device to be worn by a user having two eyes; the device comprising:
a pair of transparent electronic display elements;
a support structure for holding the pair of transparent display elements in a fixed relationship, such that when worn by a user, each eye of the user has a field of view through a corresponding one of said display elements;
at least one camera element positioned on or proximal to the support structure;
a controller communicably coupled with the pair of display elements and configured to receive image signals from the at least one camera element and to determine positions on the display elements of one or more bright spots in the field of view of the user's eyes, and to produce a dimmed or darkened image at the positions on the display elements so as to reduce a brightness of the one or more bright spots in the user's field of view; and
a power source for providing power to the controller and to the pair of transparent electronic display elements.

2. The viewing device of claim 1, wherein the pair of transparent electronic display elements includes a pair of LCD screens.

3. The viewing device of claim 1, wherein the at least one camera element includes an optical lens focused on an image sensor, wherein the image sensor produces said image signals.

4. The viewing device of claim 3, wherein the image sensor comprises one of a CCD sensor or a CMOS sensor.

5. The viewing device of claim 1, comprising at least two camera elements, each camera element having an optical lens focused on an image sensor, wherein the image sensors produce said image signals.

6. A wearable viewing device, comprising:
a pair of transparent electronic display elements;
a support structure for holding the pair of transparent display elements in a fixed relationship to each other, such that when worn by a user, each eye of the user has a field of view through a corresponding one of said display elements;
at least one camera element positioned on or proximal to the support structure;
a controller communicably coupled with the pair of display elements and configured to receive image signals from the at least one camera element and to determine positions on the display elements corresponding to a bright spot in the field of view of the user's eyes, and to produce a dimmed or darkened image at the positions on the display elements so as to reduce a brightness of the bright spot in the user's field of view; and
a power source that supplies operating power to the controller and to the pair of transparent electronic display elements.

7. The viewing device of claim 6, wherein the pair of transparent electronic display elements includes a pair of LCD screens.

8. The viewing device of claim 6, wherein the at least one camera element includes an optical lens focused on an image sensor, wherein the image sensor produces said image signals.

9. The viewing device of claim 8, wherein the image sensor comprises one of a CCD sensor or a CMOS sensor.

10. The viewing device of claim 6, comprising at least two camera elements, each camera element having an optical lens focused on an image sensor, wherein the image sensors produce said image signals.
